(19) United States
(12) Patent Application Publication
(10) Pub. No.: US 2020/0057133 A1
(43) Pub. Date: Feb. 20, 2020

(54) DRONE DASHBOARD FOR SAFETY AND ACCESS CONTROL

(71) Applicant: INTERNATIONAL BUSINESS MACHINES CORPORATION, Armonk, NY (US)

(72) Inventors: Carlos M. Arteaga, San Antonio, TX (US); Seng C. GAN, Ashburn, VA (US); Baiju Mandalia, Boca Raton, FL (US); Brian J. Snitzer, Lancaster, PA (US)

(21) Appl. No.: 16/103,077

(22) Filed: Aug. 14, 2018

(51) Int. Cl. G01S 5/00; G08G 5/00; B64C 39/02; G06F 17/30

(52) U.S. Cl. CPC G01S 5/0027; G08G 5/0026; G08G 5/006; G08G 5/0013; B64C 2201/146; G01S 5/0072; B64C 39/024; G06F 17/30241; G08G 5/0069

(57) ABSTRACT

Approaches for registering and monitoring drones for safety and access control are provided. A computer-implemented method includes: receiving, by a computer device, location data from plural drones via low power, long range wireless transmission; updating, by the computer device, a central registry with the location data; generating, by the computer device, display data based on the location data and a location of a display device; and transmitting, by the computer device, the display data to the display device via a network.

### BACKGROUND

The present invention relates generally to drones (e.g., unmanned aerial vehicles) and, more particularly, to a centralized system and method of registering and monitoring drones for safety and access control.

Drones (also called unmanned aerial vehicles) have become increasingly available to the public and are seeing increased use in public and private airspace. There are numerous approaches proposed for managing and controlling drone traffic.

### SUMMARY

In a first aspect of the invention, there is a computer-implemented method including: receiving, by a computer device, location data from plural drones via low power, long range wireless transmission; updating, by the computer device, a central registry with the location data; generating, by the computer device, display data based on the location data and a location of a display device; and transmitting, by the computer device, the display data to the display device via a network.

In another aspect of the invention, there is a computer program product comprising a computer readable storage medium having program instructions embodied therewith. The program instructions are executable by a computing device to cause the computing device to: receive location data from plural drones via low power, long range wireless transmission; update a central registry with the location data; determine a access control area based on the location data; determine a subset of the plural drones that are currently in the access control area, predicted to fly into the access control area, or in a defined vicinity of the access control area; determine access rights in the access control area for each drone in the subset of the plural drones; and transmit a message to an operator of each drone in the subset of the plural drones indicating the determined access right for the respective drone.

In another aspect of the invention, there is system including a processor, a computer readable memory, and a computer readable storage medium. The system includes program instructions to receive location data from plural drones via low power, long range wireless transmission; program instructions to update a central registry with the location data; program instructions to determine a access control area based on the location data; program instructions to determine a subset of the plural drones that are currently in the access control area, predicted to fly into the access control area, or in a defined vicinity of the access control area; program instructions to determine access rights in the access control area for each drone in the subset of the plural drones; and program instructions to transmit a message to an operator of each drone in the subset of the plural drones indicating the determined access right for the respective drone. The program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a block diagram of the exemplary environment in accordance with further aspects of the invention.

FIG. 6 shows a flowchart of an exemplary method in accordance with aspects of the invention.

### DETAILED DESCRIPTION

The present invention relates generally to drones (e.g., unmanned aerial vehicles) and, more particularly, to a centralized system and method of registering and monitoring drones for safety and access control. Drone technology is proliferating and can be a physical danger to the public. There are limited mechanisms to restrain and control drone traffic. According to aspects of the invention, there is a centralized (e.g., cloud) system with which drones are registered. In embodiments, the registered drones constantly transmit certain data (e.g., identifier, longitude, latitude, and altitude) to the system using long range, low power wireless transmission, and the system tracks the real time location of each drone based on this data.

In a first aspect, the system provides drone location data to plural different public display devices so that each public display device can show a real time map of drones within a vicinity of the public display device. The system may also provide the drone location data to user devices via a software application (e.g., a mobile app). In embodiments, the public displays (or the software application on the user devices) may generate an alert when the drone location data satisfies predefined criteria such as, for example, a drone flying lower than a predefined altitude. In this manner, implementations of the invention provide a safety function by permitting people in the public to see a visual map of drones that are in their vicinity.

In a second aspect, the system performs a access control function by: determining a controlled flight area; determining one or more select drones from a plurality of drones in a vicinity of the controlled flight area; and transmitting a message to the one or more select drones that authorizes the one or more select drones to enter the controlled flight area. In embodiments, the system determines the one or more select drones from a plurality of drones using a bid process amongst the plurality of drones. In this manner, implementations of the invention provide a access control mechanism for drone traffic by limiting the number of drones that are authorized to enter (e.g., fly into) a determined access control area.

In a particular exemplary embodiment, there is a system for monitoring drones having low power transmission capability. The system includes: geo-regional repositories to register drones and receive transmitted three-dimensional location information of each drone; and a processor configured to perform one or more of: merge location information with other available information to generate data that may be used to produce displays of drones in current or expected environments; and project future locations of drones and determine access control areas and generate data to allow governance by an external source over the access control areas.

Aspects of the invention provide a technical solution to the problem of physical danger that is posed by unrestrained and uncontrolled drone traffic. In embodiments, the technical solution includes a centralized drone registry, a centralized drone tracking system, and a dispersed network of special purpose public display devices for displaying maps of drones and generating alerts when the drones satisfy predefined criteria. In additional embodiments, the technical solution includes a centralized system that is configured to determine access control areas and communicate with drones to authorize certain drones to enter the determined access control areas while prohibiting other drones from entering the determined access control areas. Implementations of the invention are carried out with or by particular machines including the drones themselves and also the special purpose public display devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

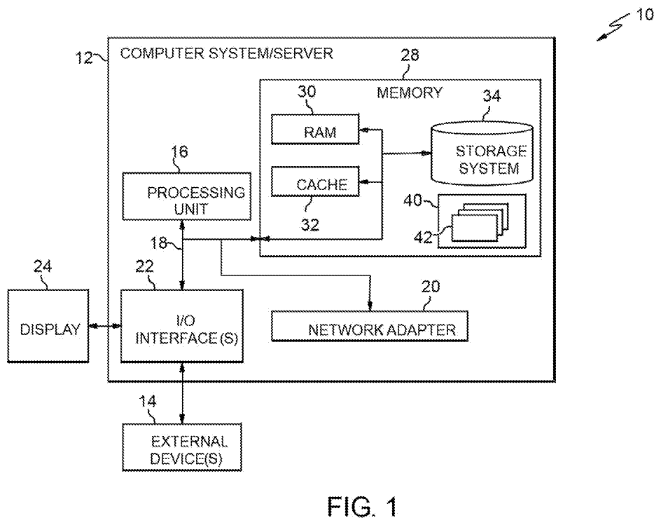

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

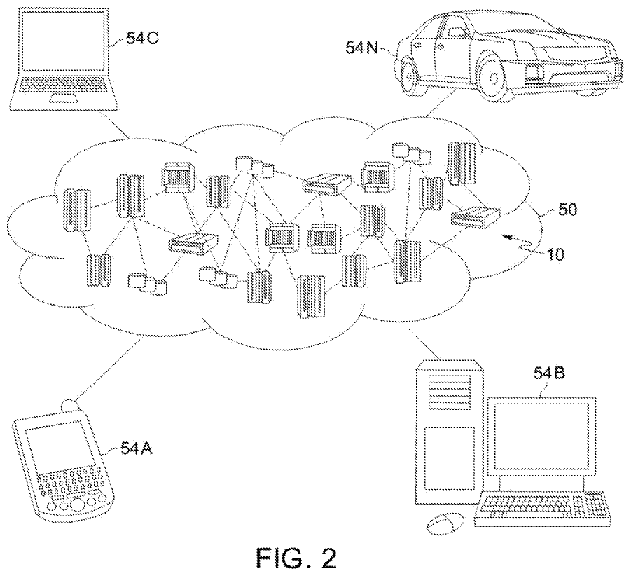

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

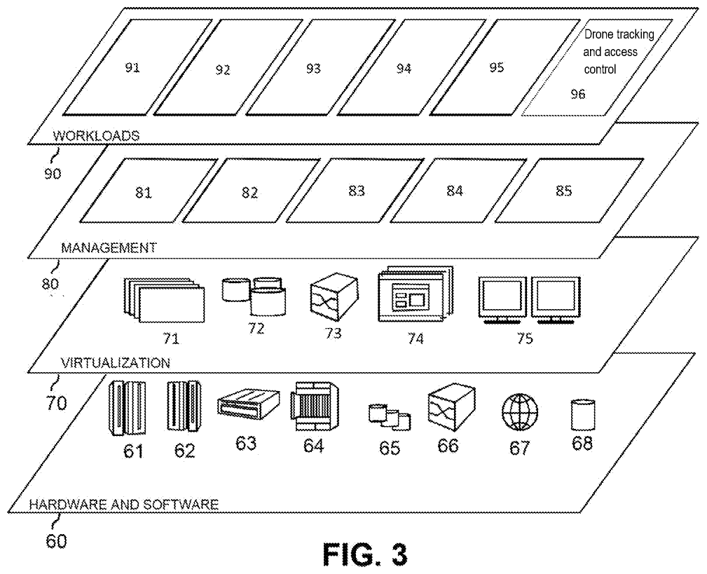

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and drone tracking and access control 96.

Implementations of the invention may include a computer system/server 12 of FIG. 1 in which one or more of the program modules 42 are configured to perform (or cause the computer system/server 12 to perform) one of more functions of the drone tracking and access control 96 of FIG. 3. For example, the one or more of the program modules 42 may be configured to: receive location data from plural drones via long range, low power wireless transmission; provide drone location data to plural different public display devices so that each public display device can show a real time map of drones within a vicinity of the public display device; determine a controlled flight area; determine one or more select drones from a plurality of drones in a vicinity of the controlled flight area; and transmit a message to the one or more select drones that authorizes the one or more select drones to enter the controlled flight area.

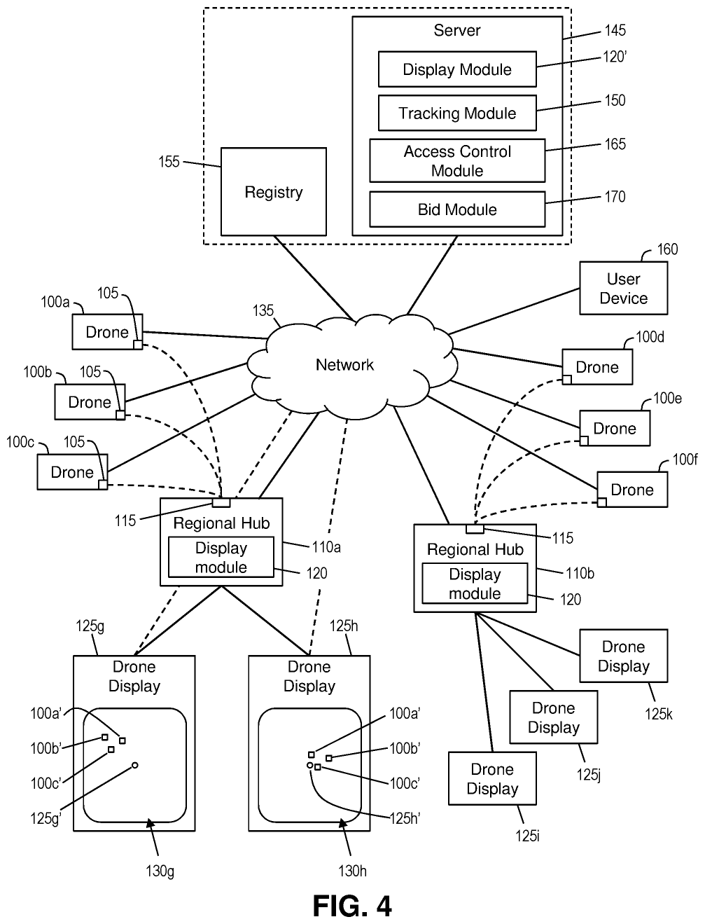

FIG. 4 shows a block diagram of an exemplary environment in accordance with aspects of the invention. In embodiments, the environment includes a plurality of drones (e.g., UAVs) 100a-f where “f” may represent any number of drones flying at any one or more locations. Each of the drones 100a-f may include conventional or later developed components including for example and without limitation: a body/frame/chassis; a power supply; a propulsion system; an altimeter; a location determining system (e.g., global positioning system (GPS)); and a wireless communication system for communicating with a respective drone controller device. Each of the drones may also include a computer processor and a computer memory that are configured to run software that serves to control functions of the drone. In embodiments each drone 100a-f additionally includes a low power, long range transmitter 105 that is configured to transmit drone location data to one or more regional hubs 110a-b each of which includes a low power, long range receiver 115.

In embodiments, the low power, long range transmitter 105 is a LoRa transmitter and the low power, long range receiver 115 is a LoRa receiver. LoRa is a digital wireless data communication IoT (Internet of Things) technology that enables very-long-range transmissions with low power consumption. For example, a LoRa transmitter may have a battery that lasts two years and is capable of transmitting low data rate transmissions up to 15 kilometers. Most conventional wireless transmission is either low power or long range, but not both. For example, long range wireless technologies such as CDMA/FDD, TDMA/FDD, OFDM, Flash-OFDM, and OFDMA all have high power usage that limits their typical battery life to a maximum of about 1 week. On the other hand, low power wireless technologies such as NFC, ZigBee, Wi-Fi, and LE Bluetooth are all short range with a maximum range of about 280 meters. By configuring the drones 100a-f with LoRa transmitters, the drones 100a-f are provided with a low power and long range wireless transmission system that is suited for the low data rate transmissions involved in various implementations of the invention. Aspects of the invention are not limited to using LoRa transmission, however, and other suitable low power, long range transmission techniques may be used. For example, an alternative embodiment may utilize Narrowband IoT (NB-IoT) or other suitable low power long range wireless communication.

In embodiments, each regional hub 110a-b is a special purpose computer device that includes the low power, long range receiver 115 and one or more elements of the computer system/server 12 as described with respect to FIG. 1. Each respective regional hub 110a-b is configured to receive data transmitted by drones that are within range of the respective regional hub 110a-b. In the example shown in FIG. 4, the regional hub 110a might receive data transmitted by drones 110a-c, while the regional hub 110a might receive data transmitted by drones 110d-f. The particular drones that are within range of any one of the regional hubs 110a-b at any given time may change due to the changing locations of the drones in flight.

In accordance with aspects of the invention, the data transmitted by the drones to the regional hubs 110a-b includes drone location data, which may include: an identifier of the drone that is transmitting the data; and a longitude, latitude, and altitude of the drone that is transmitting the data. The identifier of the drone may be any unique identifier, such as serial number of the drone or a user name of a user associated with the drone, and may be stored in the computer memory onboard the drone. The longitude and latitude may be determined from the GPS onboard the drone, and the altitude may be determined from the altimeter onboard the drone. In an embodiment, the drone location data include flight path (e.g., directional) information about the drone.

According to aspects of the invention, each regional hub 110a-b may include a display module 120 that is configured to create display data, based on the drone location data, for display on one or more drone displays 125g-k. The display module 120 may include one or more program modules 42 as described with respect to FIG. 1.

Each drone display 125g-k may be a computer device that includes a visual display screen that is configured to visually display the display data received from one of the regional hubs 110a-b. In embodiments, each drone display 125g-k is arranged at a publicly accessible location, such as on or in a kiosk at any of a sidewalk, a park, and an outdoor sporting venue. In embodiments, each drone display 125g-k is associated with and receives data from a single one of the regional hubs 110a-b. In the example shown in FIG. 4, drone displays 125g-h are associated with and receive data from regional hub 110a, while drone displays 125i-k are associated with and receive data from regional hub 110b. Any number of drone displays may be associated with each of the regional hubs.

In accordance with aspects of the invention, the location (e.g., GPS coordinates) of each of the drone displays is stored in the memory of the regional hub associated with the drone display. For example, the regional hub 110a may store data defining each of: a location of the drone display 125g; and a location of the drone display 125h. In this manner, the display module 120 of the regional hub 110a may use the drone location data (received from the drones 100a-c) to create first display data that is specific to the drone display 125g and second display data that is specific to the drone display 125h. The display data may comprise, for example, a map that includes a visual representation of the location of any of the drones 100a-c in the vicinity of the drone display. Since the drone display 125g and the drone display 125h are at different locations, the respective maps that are shown at each drone display would differ from one another.

For example, based on the drone location data received from each of the drones 100a-c, the display module 120 of the regional hub 110a may generate data that defines a first map 130g that is displayed on the drone display 125g and a second map 130h that is displayed on the drone display 125h. As illustrated in the example of FIG. 4, the first map 130g provides a visual representation of the location of the drones 100a-c (indicated in the map 130g by icons 100a′, 100b′, and 100c′) relative to the location of the drone display 125g (indicated in the map 130g by icon 125g′). Still referring to the example in FIG. 4, the second map 130h provides a visual representation of the location of the drones 100a-c (indicated in the map 130h by icons 100a′, 100b′, and 100c′) relative to the location of the drone display 125h (indicated in the map 130h by icon 125h′). The first map 130g and the second map 130h are created by the display module 120 using the same drone location data, but the maps are different due to the different locations of the respective drone displays 125g and 125h. In this manner, the first drone display 125g shows a map 130g that visually depicts the current location of the drones 100a-c relative to the first drone display 125g, while simultaneously the second drone display 125h shows a map 130h that visually depicts the current location of the drones 100a-c relative to the second drone display 125h. In this manner, a person viewing one of the drone displays 125g or 125h may quickly and easily view the locations of drones in the vicinity.

In embodiments, the display module 120 may update the data sent to the drone displays 125g-h as new drone location data is received from the drones 100a-c, such that the maps 130g-h may be updated in real time. Moreover, the maps 130g-h may include representations of streets and/or geographic features around the respective drone displays 125g-h.

Regional hub 110b may receive data from drones 100d-f and provide display data to drone displays 125i-k in a similar manner as that described with respect to regional hub 110a. Implementations of the invention may include any number of regional hubs, with each of the regional hubs having any desired number of associated drone displays. Each of the respective regional hubs may operate simultaneously and independently of the other ones of the regional hubs. Moreover, during flight, a drone (e.g., drone 100a) may fly out of range of one of the regional hubs (e.g., regional hub 110a) and into the range of another one of the regional hubs (e.g., regional hub 110b). In this case, the maps at drone displays 125g-h would no longer display an indication of the drone 100a, whereas at least one of the maps at drone displays 125i-k would start showing an indication of the drone 100a.

In accordance with aspects of the invention, the drones 100a-f may communicate directly with respective ones of the regional hubs 100a-b via wireless transmission from the transmitters 105 to the receivers 115, e.g., as indicated with dashed lines in FIG. 4. In other implementations, e.g., as indicated with solid lines in FIG. 4, the drones 100a-f may communicate with respective ones of the regional hubs 100a-b via a communications network 135 that may comprise one or more computer networks (such as a LAN, WAN, or the Internet) and/or one or more telecommunications networks (such as a cellular network).

In embodiments, the regional hubs 100a-b may communicate directly with their respective associated drone displays 125g-k, e.g., via a dedicated private connections. Alternatively, each of the regional hubs 100a-b and each of drone displays 125g-k may be individually connected to the network 135, such that communication between the regional hubs 100a-b and their respective associated drone displays 125g-k is performed via the network 135. In this latter embodiment, the network 135 may comprise a cloud computing environment, and each of the regional hubs 100a-b and each of drone displays 125g-k may comprise a respective cloud computing node in the cloud computing environment (e.g., such as cloud computing nodes 10 in cloud computing environment 50 of FIG. 2).

In another embodiment, the regional hubs 110a-b receive the drone location data from the drones 100a-f via transmission between the LoRa transmitters 105 and LoRa receivers 115. In this embodiment, each of the regional hubs 110a-b transmits the drone location data to a central (e.g., cloud) server 145 via the network 135. The server 145 may be a computer server that comprises one or more components of the computer device 12 of FIG. 1. The server 145 may include a display module 120, a tracking module 155, a access control module 165, and a bid module 170, each of which may comprise one or more program modules 42 as described with respect to FIG. 1. In this embodiment, the server 145 includes a display module 120′ that is configured to generate the display data for each of the drone displays 125g-k based on the drone location data and the location of each of the drone displays 125g-k, e.g., in a manner similar to that described with respect to display module 120. In this embodiment, the server 145 transmits (e.g., pushes) respective display data to each of the respective drone displays 125g-k via the network, and each of the respective drone displays 125g-k displays a map (e.g., map 130g, 130h, etc.) based on the display data received from the server 145. In this implementation, the regional hubs 110a-b receive the drone location data from the drones 100a-f and forward this data to the server 145, and the server 145 then generates the display data that is displayed as a map at the drone displays 125g-k. In this manner, the processing that is used to generate the display data is performed at the server 145 instead of each of the regional hubs 110a-b, such that the regional hubs 110a-b need not be equipped with the display module 120.

In this embodiment, the server 145 may include a tracking module 155 that stores all of the received drone location data in a central registry 155. For example, in response to the server 145 receiving drone location data from one of the regional hubs 100a-b, the tracking module 155 may update a database of the registry 155 with the new location data (e.g., longitude, latitude, and altitude) for the drone identified in the drone location data (e.g., by the unique identifier included in the drone location data). The display module 120′ may access the location data of each drone 100a-f that is stored in the registry 155 to generate the display data for the drone displays 125g-k. The server 145 and the registry 155 may be separate devices (or separate respective combinations of devices) that communicate with one another via the network 135. Alternatively, the server 145 and the registry 155 may be included in a single device (or a single combination of devices).

In accordance with further aspects of the invention, the display module 120′ of the server 145 may generate and transmit display data to a private user device 160, such as a smartphone, table computer, smart watch, etc. In embodiments, the user device 160 includes a software application (such as a mobile app) that transmits a request to the server 145 via the network 135. The request may include a GPS location of the user device 160. In response to receiving the request, the display module 120′ may determine which drones are within a predefined radius of the GPS location of the user device 160 by analyzing the drone location data stored in the registry 155, and may create display data for a map to be displayed on the user device 160 based on the drone location data and the GPS location of the user device 160. Upon receipt of the display data from the server 145, the user device 160 may display a map similar to the maps (e.g., map 130g) that are displayed on the drone displays (e.g., drone display 125g).

According to aspects of the invention, the display module 120 (or the display module 120′) may cause one or more of the drone displays 125g-h to output an alert when a predefined condition is satisfied. As described herein, a component of the drone location data that is transmitted from each drone to each regional hub is the altitude of the drone. In embodiments, the display module 120 (or the display module 120′) is configured to compare the altitude data to a stored threshold amount, and to cause one of the drone displays 125g-h to generate an alert when the altitude of one of the drones is less than the threshold amount. For example, when threshold amount is 100 feet and the altitude of the drone 100b is 95 feet, the display module 120 (or the display module 120′) may cause the drone display 125g to generate an alert based on this condition. The alert may be, for example, a visual indication on the display screen of the drone display 125g, e.g., such as a visual indication in the map 130b. The alert may additionally or alternatively be an audible alert that is output by an audio speaker that is part of the drone display 125g. The threshold amount and the type of alert may be configurable by a system administrator.

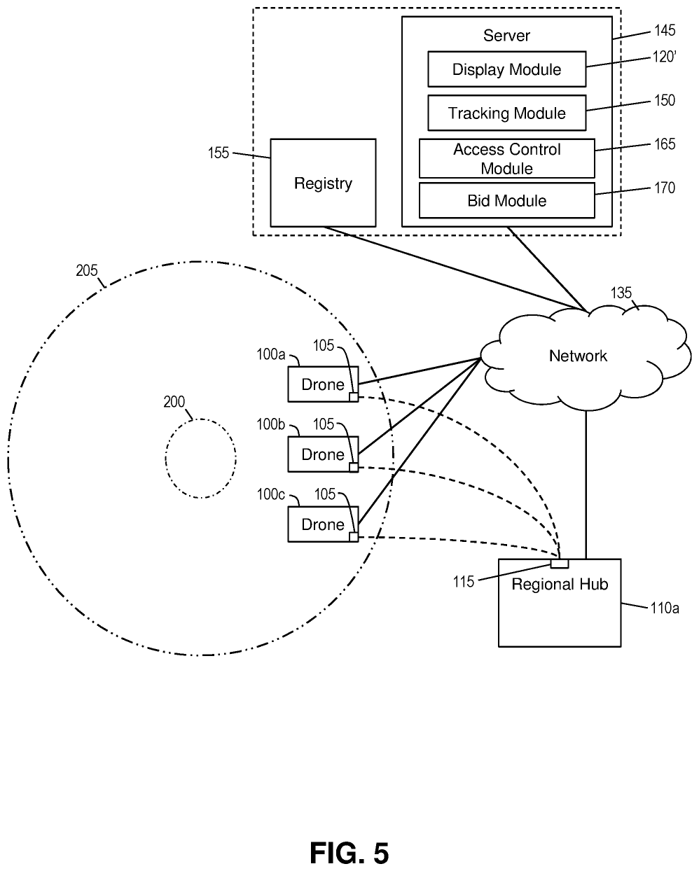

FIG. 5 illustrates a drone traffic access control implementation in accordance with aspects of the invention. FIG. 5 shows the environment of FIG. 4 with some elements omitted for clarity. In particular, FIG. 5 shows the drones 100a-c, the regional hub 110a, the network 135, the server 145 and the registry 155. As described with respect to FIG. 4, the regional hub 110a receives LoRa transmissions of drone location data from each of the drones 100a-c and forwards this drone location data to the server 145 via the network 135. As further described with respect to FIG. 4, the tracking module 150 of the server 145 updates the registry 155 with the location data of each of the drones 100a-c.

According to aspects of the invention, the server 145 comprises a access control module 165 that is configured to determine a access control area 200 and to communicate with the drones 100a-c to control access of the drones 100a-c in the access control area 200. In embodiments, the access control module 165 determines the access control area in one of three ways: (i) by predicting that a number of drones will be in a same area based on historic drone location data; (ii) by determining in real time that plural drones are in a same area; and (iii) by receiving input (e.g., from a user such as an administrator) defining a access control area.

In the first method of determining the access control area, the access control module 165 may use data from the registry 155 to predict the future flight path of each of drones 100a-c. Any suitable prediction methods may be programmed into the access control module 165 for this purpose. As but one example, the access control module 165 may predict a flight path for a particular drone (e.g., drone 100a) based on extrapolating a curve that is fit to the most recent ten locations (e.g., longitude, latitude, and altitude) of the particular drone. The access control module 165 may perform this prediction for each of the drones 100a-c, and may update the predicted flight path for each of the drones as new drone location data is received. In an embodiment, alternatively to predicting the flight path, the system may obtain flight path data from the drones 100a-c. For example, in an embodiment, the drone location data includes this flight path (e.g., directional) information about the drone. The access control module 165 may compare the predicted/obtained flight paths for each of the drones 100a-c and determine when the drones 100a-c will all be within a same area. In embodiments, the same area may be defined as an imaginary sphere in the sky defined by a center and a radius, and the access control module 165 may determine, based on the predicted/obtained flight path for each of the drones, that each of the drones will be within the sphere at a same time in the future. The radius may be a predefined value that is configurable by system user such as an administrator. When it is determined that plural ones of the drones 100a-c will be in the same area at the same time, the same area may be deemed the access control area 200.

In the second method of determining the access control area, the access control module 165 may use data from the registry 155 to determine in real time that all of drones 100a-c are currently within a same area. In this embodiment, the same area may be defined as an imaginary sphere in the sky defined by a center and a radius, and the access control module 165 may determine, based on the current location data of each the drones, that each of the drones is currently within the sphere. The radius may be a predefined value that is configurable by an administrator. When it is determined that plural ones of the drones 100a-c are within the same area at the same time, the same area may be deemed the access control area 200.

In the third method of determining the access control area, the access control module 165 may receive user input (e.g., from a system user such as an administrator) defining a access control area. In this embodiment, the access control area may be defined by a geo-fence that is created based on the user input. The user input may be any suitable user input for defining a geo-fence, including but not limited to drawing a shape on a computer displayed map (e.g., using a stylus, finger, or mouse) and converting the edges of the shape to coordinate data (e.g., longitude and latitude) that defines the geo-fence, which in turn defines the access control area 200.

In accordance with aspects of the invention, based on determining the access control area 200, the access control module 165 may limit access of the drones 100a-c to the access control area 200 by sending command instructions to the drones 100a-c. For any of the drones that are currently within the access control area 200, the access control module 165 may send a message to a registered operator of the drone, wherein the message instructs the operator to fly the drone out of the access control area and to keep the drone out of the access control area. As described herein, the operator of each drone 100a-c registers their drone with the registry 155, and this registration may include contact information for the operator of the drone (e.g., short message service (SMS) number, multimedia message service (MMS) number, email address, etc.). In embodiments, when the access control module 165 determines that a particular drone (e.g., drone 100a) is currently within the access control area 200, the access control module 165 accesses the registry 155 and obtains the contact information for the operator of the particular drone (e.g., drone 100a), and the access control module 165 then transmits the message regarding the access control area to the operator of the particular drone (e.g., drone 100a) using the obtained contact information. The access control module 165 may perform this operation individually for each drone that is currently within the access control area 200.

Additionally, for any of the drones 100a-c that are not yet within the access control area 200 but are predicted to fly into the access control area 200, the access control module 165 may send a message to the operator of the drone to avoid the access control area 200 before the drone enters the access control area 200. For example, based on determining that a particular drone (e.g., drone 100a) will fly into the access control area 200, the access control module 165 may access the registry 155 and obtain the contact information for the operator of the particular drone (e.g., drone 100a) and then transmit the message regarding the access control area to the operator of the particular drone (e.g., drone 100a) using the obtained contact information. The access control module 165 may perform this operation individually for each drone that is predicted to fly into the access control area 200.

Additionally, for any of the drones 100a-c that are not yet within the access control area 200 but are within a predefined vicinity 205 of the access control area 200, the access control module 165 may send a message to the operator of the drone to remain outside of the access control area 200. In embodiments, when the user input is used to define the access control area 200, the system may automatically notify all drones that are within a predefined vicinity 205 of the access control area 200. The predefined vicinity 205 may be defined automatically by the system (e.g., by defining the vicinity as some multiple of the size of the access control area in all directions) or may be defined manually by the user. Based on determining that a particular drone (e.g., drone 100a) is within the predefined vicinity 205, the access control module 165 may access the registry 155 and obtain the contact information for the operator of the particular drone (e.g., drone 100a) and then transmit the message regarding the access control area to the operator of the particular drone (e.g., drone 100a) using the obtained contact information. The access control module 165 may perform this operation individually for each drone that is within the predefined vicinity 205.

In all of the described methods of messaging the operators of the drones regarding the access control area 200, the message that is sent to the operators may include a request for a bid for exclusive access to the access control area 200. In this manner, all of the drones 100a-c that are predicted to fly into the access control area 200, that are currently within the access control area 200, or that are within a vicinity 205 of the access control area 200 may be prompted to bid for exclusive access to the access control area 200. In embodiments, the message that is sent from the server 145 to the operators of the drones may include data that defines parameters of the bid process. In embodiments, these parameters are determined by a bid module 170 and include, for example and without limitation: a definition of the access control area in both time (e.g., from time t1 to time t2) and location (e.g., coordinates defining the access control area); a time deadline for submitting a response to the request for bids; and special rules such as minimum bid, fixed price to the first responder, etc.

In accordance with this embodiment, the bid module 170 receives bids from the operators of the drones, determines a winning one or more drones from the bids, and transmits a message to the operator of the winning drone(s). The winning drone(s) may be determined using any desired auction rules. As one example, the bid module 170 determines the winner as the first drone that responded to the request for bids and whose offer satisfies a minimum price rule. As another example, the bid module 170 determines the winner as the single bid that offers the highest price. The auction may be configured to establish only one winner or plural winners. For example, the auction may be configured to grant two drones exclusive access to the access control area.

Based on determining the winning drone(s), the access control module 165 transmits a message to the operator(s) of the winning drone(s) using the contact information of the operator(s) of the winning drone(s). The message may include data that informs the operator(s) that they have won the auction and that they are permitted to fly their drone into the access control area 200. The message may include data that defines a time period of exclusivity for the winning drone in the access control area 200.

Based on determining the winning drone(s), the access control module 165 also transmits a message to the operator of each of the drone that is not the winning drone using the contact information of the respective operators. The message may include data that informs the operator that they did not win the auction, and that they are to keep their drone outside the access control area 200. The message may include data that defines a time period of that the non-winning operator must keep their drone out of the access control area 200.

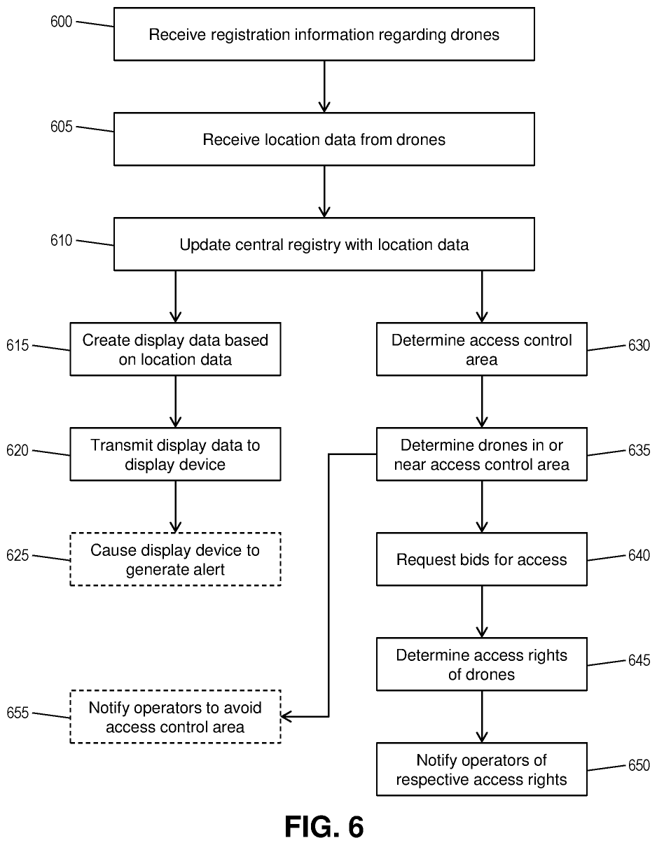

FIG. 6 shows a flowchart of an exemplary method in accordance with aspects of the present invention. Steps of the method may be carried out in the environment of FIGS. 5 and 6 and are described with reference to elements depicted in FIGS. 5 and 6.

At step 600, the system receives registration information associated with plural different drones. In embodiments, and as described with respect to FIG. 4, the operator of each drone 100a-f registers their drone with the registry 155. The registration may include the operator of each drone providing user input that defines: a unique identifier of their drone (e.g., serial number, drone identification number, etc.), and contact information for the operator (e.g., short message service (SMS) number, multimedia message service (MMS) number, email address, etc.).

At step 605, the system receives location data from drones that are in flight. In embodiments, and as described with respect to FIG. 4, the drones 100a-f transmit drone location data to regional hubs 110a-b using low power, long range wireless transmission. The drone location data may include: the unique identifier (e.g., as defined in the registration at step 600) and the longitude, latitude, and altitude of the drone (e.g., as determined by sensors on the drone). The drone location data may include may also include flight path (e.g., directional) data. In embodiments, the regional hubs 110a-b transmit the drone location data to the server 145. In this manner, the server 145 ultimately receives the drone location data that was initially transmitted via low power, long range wireless transmission.

At step 610, embodiments, the server 145 updates the registry 155 with the location data received from the drones. In embodiments, and as described with respect to FIG. 4, the tracking module 150 updates a database in the registry to include location data received from one or more of the drones.

At step 615, the system creates display data based on the location data. In embodiments, and as described with respect to FIG. 4, the display module 120′ of the server 145 creates display data based on a location of a display device and a determination of which drones are within a vicinity of the display device. The display device may be one or more drone displays 125g-k or may be a user device 160. By comparing the location of the display device to the drone location data stored in the registry 155, the display module 120′ may create a map that is specific to each display device and that shows the location of one or more drones relative to the respective display device.

At step 620, the system transmits the display data to the display device. In embodiments, and as described with respect to FIG. 4, the server 145 transmits the display data (e.g., map data) to one or more display devices (e.g., drone displays 125g-k or user device 160) for display by the display device. As described herein, due to different display devices being at different locations, different display devices can be provided with different maps (e.g., maps 103g-h) simultaneously.

At step 625, the system causes one or more of the display devices to generate an alert. In embodiments, and as described with respect to FIG. 4, the server 145 may determine that the drone location data satisfies one or more predefined conditions, and may send a signal to one or more of the display devices based on this determination. The signal may cause the display device to output a visual and/or audible alert.

At step 630, the system determines a access control area. In embodiments, and as described with respect to FIG. 5, the server 145 uses the location data from the registry 155 to determine a access control area in one or more of the ways consisting of: (i) predicting that a number of drones will be in a same area based on historic drone location data; (ii) determining in real time that plural drones are in a same area; and (iii) receiving input (e.g., from a user such as an administrator) defining a access control area.

At step 635, the system determines drones that are in or near the access control area from step 630. In embodiments, and as described with respect to FIG. 5, the server 145 uses the determined access control area the location data from the registry 155 to determine: drones that are predicted to fly into the access control area within a certain time; drones that are currently within the access control area; and drones that are within a defined vicinity of the access control area.

At step 640, the system requests bids from the drones identified at step 635 for access to the access control area. In embodiments, and as described with respect to FIG. 5, the server 145 sends a message to the operator of each drone identified at step 635, wherein the message includes data defining the access control area and prompting the operator to submit a bid to an auction for exclusive access to the access control area.

At step 645, the system determines access rights in the access control area for each of the drones identified at step 635. In embodiments, and as described with respect to FIG. 5, the server 145 receives bids from one or more of the drones identified at step 635 and determines one or more winners based on the received bids and the auction rules. The access rights are determined based on the winner(s) and loser(s) of the auction.

At step 650, the system notifies the operators of the drones of their respective access rights based on the results of the auction. In embodiments, and as described with respect to FIG. 5, the server 145 transmits a message to the operator(s) of the one or more winning drones, the message informing the operator(s) of their winning the auction and other data defining the exclusive access (e.g., a time period of exclusive access). Step 650 may also include the server 145 transmitting a message to the operator(s) of one or more drones that did not win the auction, the message informing the operator that they did not win and they are to keep their drone out of the access control area for a defined time period.

At step 655, alternatively to conducting an auction for exclusive access (as at step 640, 645, 650), the system may send a message to the operators of all the drones identified at step 635 to avoid the access control area. There may be instances where no access is desired, and in this case the system may inform the operators of all the identified drones that they are to keep their drones out of the access control area. The message may include data that defines the access control area as well as a time period for avoiding the access control area.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computer device, location data from plural drones via low power, long range wireless transmission;
updating, by the computer device, a central registry with the location data;
generating, by the computer device, display data based on the location data and a location of a display device; and
transmitting, by the computer device, the display data to the display device via a network.

2. The method of claim 1, wherein:
the location data is received at one or more regional hubs via the low power, long range wireless transmission between the plural drones and the one or more regional hubs; and
the location data is received by the computer device from the one or more regional hubs via the network.

3. The method of claim 2, wherein the location data of a respective one of the plural drones comprises: a drone identifier; longitude; latitude; and altitude.

4. The method of claim 1, wherein the display data defines a map visually showing a location of one or more of the plural drones relative to a location of the display device.

5. The method of claim 4, wherein:
the display device comprises a public drone display that is at a publicly accessible location; and
the transmitting the display data comprises pushing the display data to the public drone display.

6. The method of claim 4, wherein:
the display device comprises a private user device; and
the transmitting the display data comprises sending the display data to the private user device in response to receiving a request from the private user device.

7. The method of claim 1, wherein the display data comprises first display data and the display device comprises a first display device, and further comprising:
generating, by the computer device, second display data based on the location data and a location of a second display device; and
transmitting, by the computer device, the second display data to the second display device via the network.

8. The method of claim 7, wherein:
the first display data defines a first map visually showing locations of a first subset of the plural drones relative to a location of the first display device;
the second display data defines a second map visually showing locations of a second subset of the plural drones relative to a location of the second display device; and
the first map is different than the second map based on the location of the first display device being different than the location of the second display device.

9. The method of claim 1, further comprising:
determining, by the computer device, that the location data of one of the plural drones satisfies a condition;
transmitting, by the computer device, a signal to the display device that causes the display device to generate an alert based on the location data of the one of the plural drones satisfying the condition.

10. The method of claim 1, further comprising:
determining, by the computer device, a access control area based on the location data;
determining, by the computer device, a subset of the plural drones that are currently in the access control area, predicted to fly into the access control area, or in a defined vicinity of the access control area; and
transmitting, by the computer device, a respective message to an operator of each of the subset of the plural drones indicating whether the operator has permission to fly their drone in the access control area.

11. A computer program product comprising a computer readable storage medium having program instructions embodied therewith, the program instructions executable by a computing device to cause the computing device to:
receive location data from plural drones via low power, long range wireless transmission;
update a central registry with the location data;
determine a access control area based on the location data;
determine a subset of the plural drones that are currently in the access control area, predicted to fly into the access control area, or in a defined vicinity of the access control area;
determine access rights in the access control area for each drone in the subset of the plural drones; and
transmit a message to an operator of each drone in the subset of the plural drones indicating the determined access right for the respective drone.

12. The computer program product of claim 11, wherein the determining the subset of the plural drones is based on one or more from the group consisting of:
predicting that a number of the plural drones will be in a same area at a same time based on historic drone location data;
determining in real time that a number of the plural drones are in a same area; and
receiving user input defining the access control area.

13. The computer program product of claim 12, wherein the determining the access rights comprises:
transmitting a respective request to the operator of each drone in the subset of the plural drones;
receiving responses in response to the requests; and
determining at least one winner of access rights based on the received responses.

14. The computer program product of claim 12, wherein the program instructions further cause the computing device to:
generate display data based on the location data and a location of a display device; and
transmit the display data to the display device via a network.

15. The computer program product of claim 14, wherein the display data defines a map visually showing a location of one or more of the plural drones relative to a location of the display device.

16. The computer program product of claim 12, wherein the computer program product is included in software provided as a service in a cloud environment.

17. The computer program product of claim 12, wherein the computer program product is included in a platform provided as a service in a cloud environment.

18. A system, comprising:
a processor, a computer readable memory, and a computer readable storage medium;
program instructions to receive location data from plural drones via low power, long range wireless transmission;
program instructions to update a central registry with the location data;
program instructions to determine a access control area based on the location data;
program instructions to determine a subset of the plural drones that are currently in the access control area, predicted to fly into the access control area, or in a defined vicinity of the access control area;
program instructions to determine access rights in the access control area for each drone in the subset of the plural drones; and
program instructions to transmit a message to an operator of each drone in the subset of the plural drones indicating the determined access right for the respective drone,
wherein the program instructions are stored on the computer readable storage medium for execution by the processor via the computer readable memory.

19. The system of claim 18, wherein:
the determining the subset of the plural drones is based on one or more from the group consisting of: predicting that a number of the plural drones will be in a same area at a same time based on historic drone location data; determining in real time that a number of the plural drones are in a same area; and receiving user input defining the access control area and
the determining the access rights comprises: transmitting a respective request to the operator of each drone in the subset of the plural drones; receiving responses in response to the requests; and determining at least one winner of access rights based on the received responses.

20. The system of claim 18, wherein the program instructions further comprise:
program instructions to generate display data based on the location data and a location of a display device, wherein the display data defines a map visually showing a location of one or more of the plural drones relative to a location of the display device; and
transmit the display data to the display device via a network.
